(19) United States
(12) Patent Application Publication
(10) Pub. No.: US 2025/0243972 A1
(43) Pub. Date: Jul. 31, 2025

(54) SELF-INSERTING TREE HANGER

(71) Applicant: Edward Andrew Blackston, North Augusta, SC (US)

(72) Inventor: Edward Andrew Blackston, North Augusta, SC (US)

(21) Appl. No.: 19/037,860

(22) Filed: Jan. 27, 2025

Related U.S. Application Data
(60) Provisional application No. 63/624,857, filed on Jan. 25, 2024.

(51) Int. Cl. F16M 13/02; A01M 31/02; B25F 5/02; F41B 5/14

(52) U.S. Cl. CPC F16M 13/02; A01M 31/02; B25F 5/02; F41B 5/1453

(57) ABSTRACT

A tree hanger includes a controllable motor disposed within a body of the tree hanger, a penetrating member operably coupled to the controllable motor and extending from a first end of the body, the penetrating member being configured to rotate and penetrate into a supporting surface to support the tree hanger, a hanger arm extending from the body at a second end of the body that is opposite the first end, the hanger arm being configured to support an item on a utility end of the hanger arm via a hanging member, wherein the hangar arm includes a pivoting element configured to change an angle of extension of the hanger arm from the body.

### CROSS-REFERENCE TO RELATED APPLICATIONS

This application claims the benefit of U.S. Provisional Application No. 63/624,857 filed on Jan. 25, 2024, the entire contents of which are hereby incorporated herein by reference.

### TECHNICAL FIELD

The subject matter disclosed herein is generally directed to tool accessory technology, and, more particularly, temporary storage technology for tools.

### BACKGROUND

Outdoor activities are common throughout the world. One aspect of the “great outdoors” that is commonly encountered, and often frustrating, is the lack of convenient apparatus onto which to temporarily stow tools, such as outdoor supplies including hunting equipment, camping supplies, foodstuffs, clothing, etc. This is very frequently the case for hunters. A hunter in a tree stand, often 20 to 25 feet off the ground, often finds herself suspended in the air needing to support tools such as a bow or rifle, a coat, flashlight, etc., with no place to secure such items. Indeed, the platform the hunter rests upon is, at best, a precarious perch and a hunter might easily fall if rendered off balance trying to arrange their equipment.

Prior attempts at solving this issue include U.S. Pat. No. 9,133,978, Scott, which provides a mountable attachment apparatus that includes an attachment shaft that is at least partially tapered. A combination headless drive shaft-hang shaft is connected with the attachment shaft. The headless drive shaft-hang shaft includes a hang shaft connected to the attachment shaft and the hang shaft includes a mounting element in the hang shaft. The combination headless drive shaft-hang shaft also includes a drive shaft connected to the hang shaft and the drive shaft includes a drive element in the drive shaft. In combination, the attachment shaft and the combination headless drive shaft-hang shaft form a single, rigid, undivided, straight shaft. Further, a stability plate is connected transversely between, and extending outwardly from, the attachment shaft and the hang shaft where the stability plate includes a first side facing the attachment shaft and a second side.

U.S. Pat. No. 10,866,493, Demers, provides a camera mounting system where the user can safely install a camera high in a tree without having to leave the ground. The camera mounting system is comprised of a tree attachment, ball mount, and camera mount. The system is installed by using an extension pole with releasable capture means for installation and removal of the system. This system also has a multi-mount adapter, which allows a user to install multiple wire connected mounted components on one tree attachment, or in different elevated positions. Once installed, a camera can be accurately aimed by using a laser attachment and standard laser pen light. This system is further comprised of a saw attachment, which can be used to clear branches from the installation area of the tree being utilized.

U.S. Pat. No. 9,593,803, Scott, provides a hanger system that includes a base mount with a connection device conformed to connect with a separate object. The base mount further includes a mounting stud. An outer receiver head is provided with a quick connect female receiver conformed to connect with and disconnect from the mounting stud and when connected with the mounting stud to secure the connection in place and the outer receiver head includes a performance device.

U.S. Pat. Pub. No. 2007/0205344, Liermann, provides a coupling system that allows an individual to mount various accessories to a tree or stable column. According to one exemplary embodiment, the coupling system includes a set of corresponding mating members, which have various attached accessories. Consequently, the system provides a convenient, portable, and inexpensive means to exploit the advantages of a tree for the purposes of hunting and/or nature watching.

U.S. Pat. No. 9,593,903, Sanchez, provides a bow and arrow hunting accessory device having a mounting post assembly with a sidewall and mounting screws that insert into a tree. Further having a swivel bar assembly, and a mounting arm assembly with an accessory support and to support a hunting bow. The mounting post assembly further has a shaft. The swivel bar assembly has a housing with a hole. The hole receives the shaft when the swivel bar assembly mounts onto the mounting post assembly. The swivel bar assembly has an elongated housing with extension holes. The mounting arm assembly has a mounting arm having an actuating pin. The elongated housing receives the mounting ann, and any of the extension holes receives the actuating pin. The mounting arm assembly has a wind vane. Further having a clamp assembly that secures an umbrella.

U.S. Pat. No. 5,967,475, Johnson, discloses a Hunting Bow Hanging apparatus attachable to a tree or post comprising an “L”-shaped bracket with a lag bolt permanently attached extending from one end of the “L”-shaped bracket and screwably secured to a tree. A square aluminum outer tube is attached to the other end of the “L”-shaped bracket and has holes drilled down its length to allow for adjustment of a square aluminum inner tube insertable therein which has holes drilled that correspond to the holes of the outer tube. A locking bolt and/or pin is insertable through the holes of the outer and inner tubes to allow for length adjustment and securing of the inner tube. A hunting bow mounting bracket is provided at the end of the inner extension tube for connecting the bow or any other article to the apparatus.

U.S. Pat. No. 6,478,272, Jordan Outdoor Enterprises, LTD, provides a portable hanger, for attachment to a wood structure such as a tree, supports equipment for outdoor activity such as hunting, fishing, camping, or photography. The portable hanger comprises a rigid mounting member for attachment proximate one end to a wood structure and a swing arm pivotally connected proximate one end of the swing arm to the mounting member proximate another end of the mounting member. The swing arm extends from the one end of the swing arm to another end of the swing arm and comprises at least two rigid members pivotally connected to one another. The mounting member and the at least two rigid members of the swing arm are pivotally connected such that the portable hanger is selectively arrangeable in a compact configuration, wherein the mounting member and the at least two rigid members of the swing arm are juxtaposed, and alternatively arrangeable in an expanded configuration wherein the mounting member and the at least two rigid members of the swing arm extend end-to-end.

Citation or identification of any document in this application is not an admission that such a document is available as prior art to the present disclosure.

### SUMMARY OF SOME EXAMPLES

According to some example embodiments, a tree hanger is described that comprises a controllable motor disposed within a body of the tree hanger, a penetrating member operably coupled to the controllable motor and extending from a first end of the body, the penetrating member being configured to rotate and penetrate into a supporting surface to support the tree hanger, a hanger arm extending from the body at a second end of the body that is opposite the first end, the hanger arm being configured to support an item on a utility end of the hanger arm via a hanging member, wherein the hangar arm comprises a pivoting element configured to change an angle of extension of the hanger arm from the body.

Additionally, according to some example embodiments, a length of the hanger arm is greater than a length of the body of the tree hanger. Additionally or alternatively, according to some example embodiments, the hanging member comprises a hook or a hoop net. Additionally or alternatively, according to some example embodiments, the tree hanger further comprises a plurality of pivoting elements including the pivoting element to change a direction of extension of the hanger arm from the body. Additionally or alternatively, according to some example embodiments, the hanging member is removable and replaceable. Additionally or alternatively, according to some example embodiments, the tree hanger further comprises a handle that extends from the body in a non-parallel direction from an axis of rotation of the penetrating member. Additionally or alternatively, according to some example embodiments, the handle is pivotable. Additionally or alternatively, according to some example embodiments, the handle is pivotable into a stowed position such that the handle is configured to operate as a second hanger arm. Additionally or alternatively, according to some example embodiments, the handle comprises a second hanging member. Additionally or alternatively, according to some example embodiments, the second hanging member is a hook. Additionally or alternatively, according to some example embodiments, the second hanging member is removable and replaceable.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a self-inserting tree hanger according to some example embodiments.

FIG. 2 shows a front view of the self-inserting tree hanger of FIG. 1.

FIG. 3 shows a rear view of the self-inserting tree hanger of FIG. 1.

FIG. 4 shows a self-inserting tree hanger, according to some example embodiments, installed into a tree while supporting a bow.

FIG. 5A shows a self-inserting tree hanger, according to some example embodiments, installed into a tree while supporting a bow, with the hanger arm pivoted at a mid-span pivoting element.

FIG. 5B shows a self-inserting tree hanger, according to some example embodiments, installed into a tree while supporting a bow, with the hanger arm pivoted at an insertion point pivoting element.

FIG. 6A shows another a self-inserting tree hanger according to some example embodiments.

FIG. 6B shows the self-inserting tree hanger of FIG. 6A with the handle pivoted into a non-protruding position according to some example embodiments.

FIG. 7 shows a front view of the self-inserting tree hanger of FIG. 6A.

FIG. 8 shows a rear view of the self-inserting tree hanger of FIG. 6A.

FIG. 9 shows an example penetrating member according to some example embodiments.

FIG. 10 shows a hanger with a hoop net according to some example embodiments.

The figures herein are for illustrative purposes only and are not necessarily drawn to scale.

### DETAILED DESCRIPTION OF SOME EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than ‘y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to y′”, where ‘x’ and ‘31’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +1-0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about.” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

According to various example embodiments, a tree hanging device is described, and methods for making same, wherein the tree hanging device may be self-inserting and provides an extendable arm for hanging tools and other items such as bows, clothing, camping supplies, etc., from the distended arm of the tree hanging device, when inserted into a tree trunk or other surface.

As mention early, prior configurations all possess various limitations regarding portability, freedom of movement, ease of use, and reusability. Accordingly, it is an object of some example embodiments to provide a portable, reusable self-inserting tree hanger with an integral, powered insertion unit that allows for quick insertion into a tree or other supporting surface in order to provide a convenient and multi-functional hanging apparatus extending from the device, while also allowing for convenient removal of the device when desired.

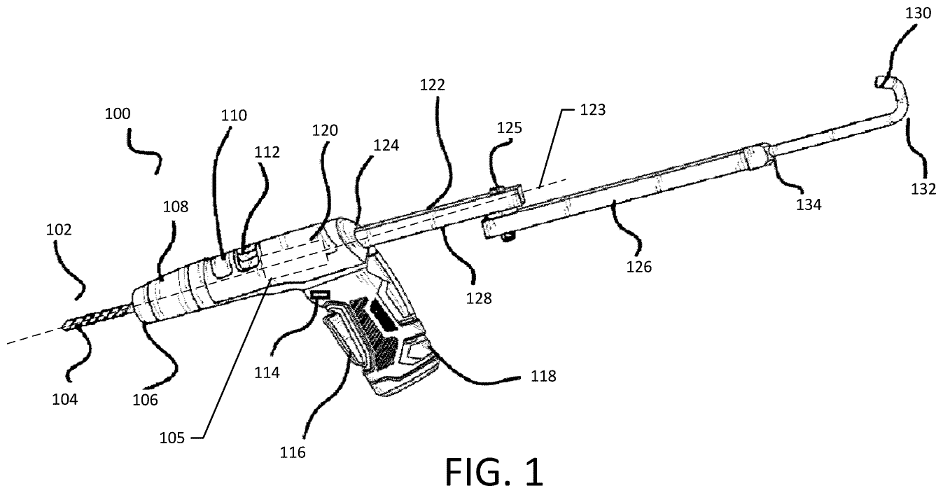

FIG. 1 shows one example embodiment of an insertable tree hanger 100. The hanger 100 may have a distal end 102 that comprises penetrating member 104, which may be a drill bit, bore bit, or other device configured to engage and penetrate a surface and remain affixed therein. Penetrating member 104 may be permanently affixed to hanger 100 or may be replaceable. For example, and not intended to be limiting, penetrating member 104 may be a drill bit, but can be replaced by another type of bit, such as a masonry, wood, metal, or other type of bit to allow hanger 100 to be used with multiple types of surfaces. Further, and again not intended to be limiting, penetrating member 104 may be a drill bit that is replaced with a multi-tooth or bore bit to enable a wider purchase or engagement into a surface rather than a narrow one as formed with a drill bit. Penetrating member 104 may be releasably affixed to chuck 106 that secures penetrating member 104 to hanger 100 as well as allows for replacement of penetrating member 104 with another bit.

According to some example embodiments, the penetrating member 104 may have a length that sufficiently long to bite into the supporting surface and support the weight of both the hanger 100 and items such as tools that are weight-rated for the hanger 100. For example, according to some example embodiments, the portion of the penetrating member 104 that may penetrate in to the supporting surface may be greater that two inches in length. In this regard, according to some example embodiments, the length and width of the penetrating member 104 may be defined for an expected load for the hanger 100. For example, a smaller penetrating member 104 may be used for clothing or rain gear. Alternatively, a longer and wider penetrating member 104 may be used for heavier loads, such as foodstuffs.

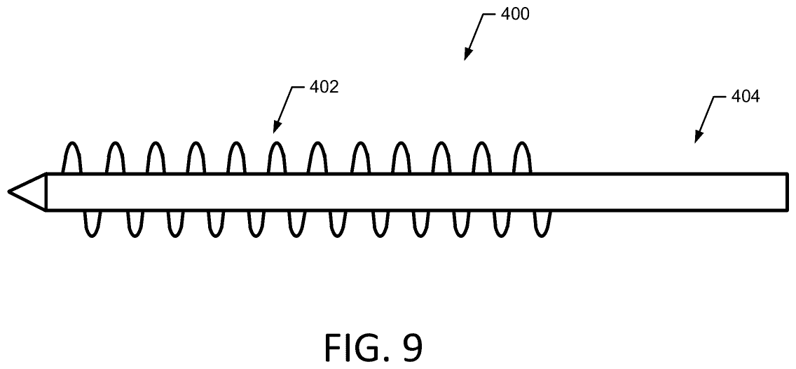

Additionally, the threading of the penetrating member 104 may be specifically defined for securing the hanger 100 into a support surface, such as a tree. In this regard, according to some example embodiments, a raised helical thread, similar to a wood screw threading may be included on the penetrating member 104. As shown in FIG. 9, a cross-section of an example penetrating member 400 is shown. The penetrating member 400 includes a single helical raised thread 402. The raised helical thread 402, screws into the support surface and tightens. This is in contrast with a drill bit with a cutting edge that may cut into the supporting surface to cut away material to form a hole. In other words, increased torque on the penetrating member 400 would operate to tighten into the supporting surface (e.g., tree). As such, to remove the penetrating member 400, and the hanger 100 that is attached thereto, the rotation on the penetrating member 400 may be revered to back out the penetrating member 400.

Returning to FIG. 1, the body portion 120 of the hanger 100 may include a controllable motor 105 that is operably coupled to, for example, a clutch torque selector 108 that is a controller of a selectable torque limiting gear set that allows the torque applied to the penetrating member 104 at selectable thresholds, which may be useful, for example, based on a hardness of the supporting surface. According to some example embodiments, the body portion 120 may also be used as rotating tool to, for example, drill a hole or the like. The clutch torque selector 108 may be utilized when the body portion 120 in operating in such a tool mode. Moreover, the controllable motor may be operably coupled to a speed control to implement, such as for purposes of example only, higher speeds for drilling into a surface and lower speeds for insertion and retention into a surface once a desired depth is achieved. According to some example embodiments, the hanger 100 may also include a level 110 allowing the user to ensure hanger 100 is entering a supporting surface at a substantially level orientation that is perpendicular to the ground or at another desired angle of entry.

The hanger 100 may also include percussion selector 112 that allows hanger 100 to convert to a hammer function via an impact mechanism that generates a hammering motion of body portion 120 into the support surface. The percussive mechanism, controller via the percussion selector 112 may provide a rapid succession of short hammer thrusts to pulverize the material to be bored, so as to provide quicker engagement with less effort. Percussion selector 112 may allow hanger 100 to switch between impact and conventional drilling, depending on the support surface into which hanger 100 is inserted, i.e., harder or softer support surfaces. The hanger 100 may also include reverse selector 114. Reverse selector 114 may allow body portion 120 of the hanger 100 to switch from clockwise to counterclockwise motion, and vice versa, acting upon the penetrating member 104. This is in order to, according to some example embodiments, not only insert the penetrating member 104 into a support surface but to allow for extraction of the penetrating member once the desired use is complete by simply by activating reverse selector 114 to back out the penetrating member 104. Reverse selector 114 may be a switch or button to reverse the direction of controllable motor 105 and thus the rotation direction of the penetrating member 104 to remove the penetrating member 104 from the support surface.

The hanger 100 may also include activation trigger 116 to allow for activation (i.e., rotation of the controllable motor 105) and deactivation (i.e., ceasing rotation of the controllable motor 105), by release of the trigger, of penetrating member 104. The handle 118 may, according to some example embodiments, not only serve as a grip for hanger 100, but may also be positioned away from parallel with (i.e., non-parallel to) penetrating member 104, such as substantially perpendicular to penetrating member 104, which gives the user additional leverage as well as the ability to more precisely “aim” hanger 100 and penetrating member 104 when in use. The handle 118 may also be configured to house a batter or define a hollow or closable and openable cavity to, for example, hold additional penetrating members 104 of varying configurations for easy storage and access while in use. Hanger body 120 may house the controllable motor 105 as a drive motor of a drill and/or impact drill in order to allow for rotation and insertion/removal of penetrating member 104 from the supporting surface.

Hanger arm 122 may releasably or permanently affix to hanger body 120 at arm insertion point 124. In some example embodiments, the hanger arm 122 may extend into a cavity at the arm insertion point 124 and be fixed thereto, and the hanger arm 122 may extend away from the arm insertion point 124, as a rigid member, along an axis 123 that is the same axis that the penetrating member 104 rotates about. In some example embodiments, the hanger arm 122 may extend away from the arm insertion point 124, as a rigid member, along an axis that is parallel to the axis 123 of rotation of the penetrating member 104. In other example embodiments, the insertion point 124 may be configured as a ball joint affixation to allow hanger arm 122 to pivot up, down, left, right, or at angle to hanger body 120 at the arm insertion point 124. Arm insertion point 124 may also be configured to lock hanger arm 122 in desired positions when selected. This prevents hanger arm 122 from “flopping” or moving during use such as via a pin insert, teeth, frictional engagement, or other means as known to those of skill in the art, in order to secure hanger arm 122 in varied positions or to allow the user to reposition hanger arm 122, even after insertion, from one position to another. This allows for a user to have a wide range of possible set positions for using hanger arm 122, something entirely missing from prior efforts as they focus on simply inserting a rod or pole in a rigid, non-movable manner.

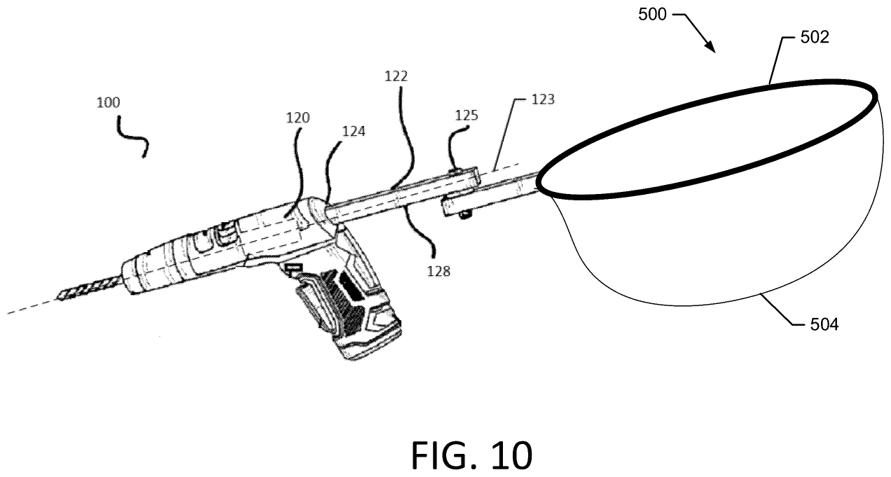

Hanger arm 122 may also be releasably affixed to hanger body 120 at insertion point 124 in order to allow for exchange of one hanger arm 122 for a second hanger arm that may be configured differently. As such, the hangar arms 122 may be removable and replaceable. For example, rather than the hook shown in FIG. 1, the hanger arm 122 may include a hoop net 500 as shown in FIG. 10. The hoop net 500 may be an alternative ending for the hanger arm 122. As such, in some example embodiments, a hanger arm 122 with a hook end may be replace with a hanger arm 122 with a hoop net 500 or other ending element at insertion point 124.

Additionally, according to some example embodiments, hanger arm 122 may have pivot 125 that allows hanger arm 122, via outer arm member 126 to move out of alignment, e.g., out of plane, with inner arm member 128. As such, the outer arm member 126 may have a relative range of motion, such as a range of motion of substantially 360 degrees, such as 340, 320, 300, 280, 260, 240, 220, 200, 180, 160, 140, 120, 100, 80, 60, 40 or 20 degrees, or measurements within these, to allow hanger arm 122 to be further position for convenient use and access. While only a single pivot 125 is shown, more pivots, such as 2, 3, 4, 5, or more pivots are contemplated. However, due to the releasable nature of hanger arm 122 from hanger body 120, the “one pivot” hanger arm 122 may be replaced with an arm with more pivots, or alternatively, with a different style pivot that allows for movement akin to a ball and socket joint such that the outer arm member 126 having arm joints capable of being moved out of plane with respect to one another and hanger body 120. Thus, pivot 125 may also be configured as a ball and socket type joint. Alternatively, pivot 125 may include a pass-through fastener, such as a bolt, with a head and threading to a receive a nut that can be loosened to pivot the outer arm member 126 and then tightened to lock the pivoted position of the outer arm member 126.

Hanger 100 may, according to some example embodiments, also include hanging member 130 at proximal end 132 of hanger arm 100 (i.e., the utility end of the hanger arm 122), herein shown as a U shaped hook, but which should not be considered so limited and may be shaped as a cup holder, multiple prong, trident, “hand” shape, semi-circle, O shape, hoop shape with a net, etc., to allow for multiple variations, implementations, and uses of hanging member 130. Hanging member 130 affixes to the last arm member, e.g., outer arm member 126, extending from the last arm member at hanging member junction 134, but the disclosure is not limited and should not be considered limited to just to two arm joints as more or less joints are envisioned and hereby disclosed.

Hanging member junction 134 may also be configured to allow flat or planar movement or configured to allow for rotational movement with respect to the arm joints, either via use of a second pivot 125 or a ball and joint configuration. Penetrating member 104, body 120, handle 118, inner arm member 128, outer arm member 126, and hanging member 130 may be made from a variety of materials, including plastic, metal, ceramic, or other materials as known to those of skill in the arm. In one instance, penetrating member 104, inner arm member 128, outer arm member 126, and hanging member 130 may be made from aluminum while hanger body 120 and hanger handle 118 may be made from plastic.

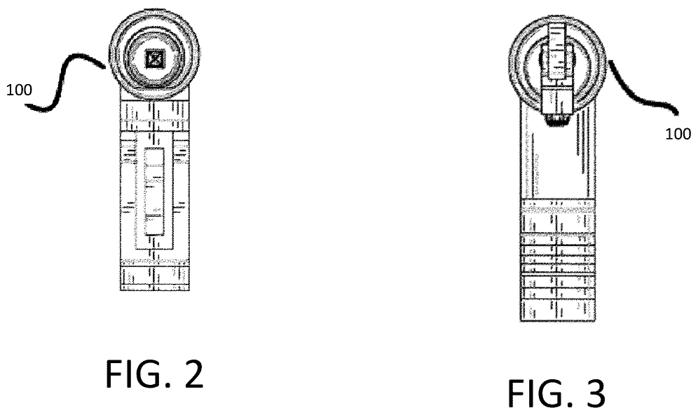

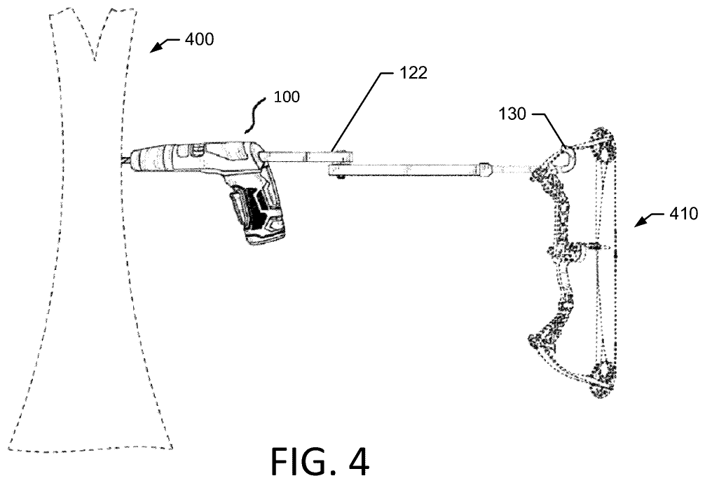

FIG. 2 shows a front view of the self-inserting tree hanger of FIG. 1. FIG. 3 shows a rear view of the self-inserting tree hanger of FIG. 1.

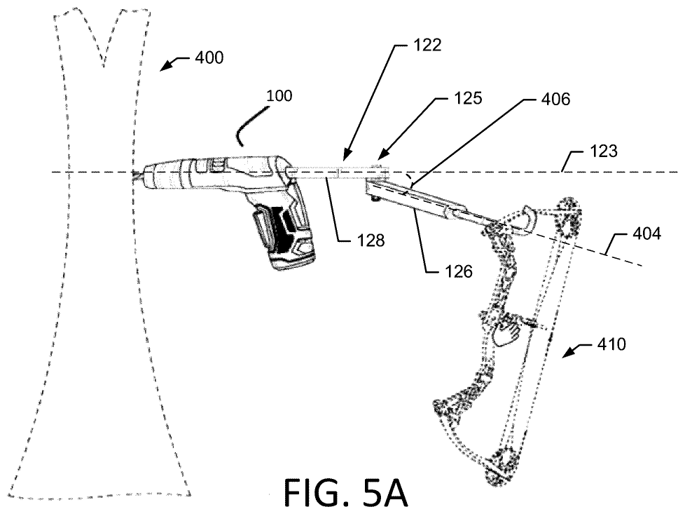

FIG. 4 shows a self-inserting tree hanger according to some example embodiments, installed into a tree 400 while supporting a bow 410. In this regard, the penetrating member 104 has been rotated and has been screwed into the tree 400. The hanger arm 122, extending from the body of the hanger 100, is in an aligned position, such that the hanger arm 122 is not angled or pivoted at any of the pivoting elements. The bow 410 engages with the hook 130 and is secured in a suspended position off the ground.

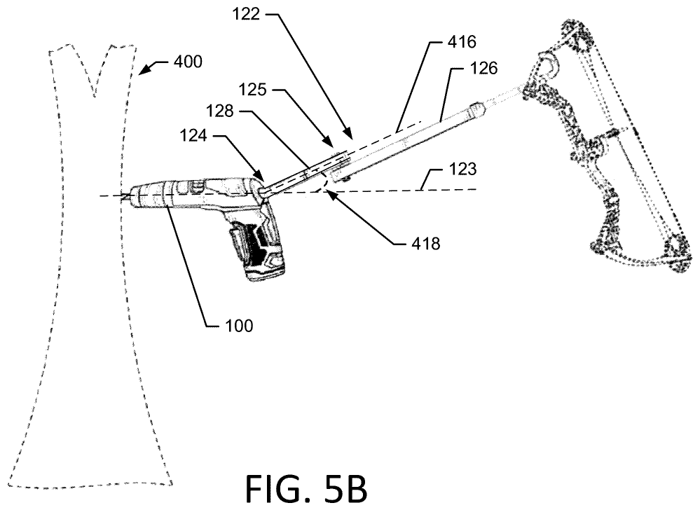

FIG. 5A shows the self-inserting tree hanger 100, as provided in FIG. 4, except that a portion of the hanger arm 122 is pivoted, at a pivoting element, into a different position. In this regard, the outer arm member 126 has been pivoted out of alignment with the inner arm member 128 via the pivot element 125. The inner arm member 128 is aligned with the axis 123, but the outer arm member 126, which may rotate within a horizontal plane, extends from the pivot element 125 at an angle 406, and has been locked into this position by a locking feature of the pivot element 125, e.g., tightening a nut. The bow 410 engages with the hook 130 and is secured in a suspended position off the ground.

FIG. 5B FIG. 5A shows the self-inserting tree hanger 100, as provided in FIG. 4, except that a portion of the hanger arm 122 is pivoted, at a pivoting element provided at insertion point 124, into a different position. In this regard, the inner arm member 128 has been pivoted out of alignment with the axis 123 in a vertical movement plane. The inner arm member 128 pivoted out of alignment with the axis 123 and extends in a direction 416 from the pivot element at the insertion point 124, such that the hanger arm 122 extends at an angle 418, and has been locked into this position by a locking feature, e.g., tightening a nut. The bow 410 engages with the hook 130 and is secured in a suspended position off the ground.

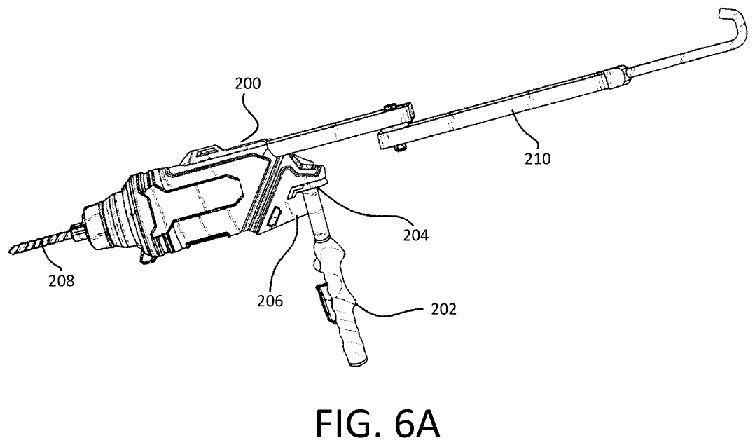

FIG. 6A shows another example embodiment of a self-inserting tree hanger 200. Self-inserting tree hanger 200 includes an ergonomically shaped handle 202 for improved grip and handling of tree hanger 200 that affixes via handle pivot 204 to alternate tree hanger body 206. Handle pivot 204 may allow for both forward and back motion, with respect to alternate tree hanger body 206, starting from a substantially 90 degree angle or being substantially perpendicular to alternate tree hanger body 206 to extending substantially parallel to alternate tree hanger penetrating member 208 and alternate tree hanger arm 210 by moving substantially ninety degrees. Handle pivot 204 may lock ergonomically shaped handle 202 into not only these positions, but any position along the approximately ninety degree arc between the two positions, such as 85, 80, 75, 70, 65, 60, 55, 50, 45, 40, 35, 30, 25, 20, 15, 10, or 5 degree positions along this arc or points between these measurements. Additionally, handle pivot 204 may be configured as a ball and socket configuration to allow for movement out of plane with respect to alternate hanger arm 210 and alternate penetrating member 208, such as by positioning along a substantially 180 degree arc from “left to right” with respect to alternate hanger body 206, as well as rotating along the substantially ninety degree arc from the perpendicular to hanger arm 210 to substantially parallel to hanger arm 210 (or alternate penetrating member 208). This wide array of positions allows for the user to avoid contorting into uncomfortable, or potentially precarious, positions, while high off the ground in a tree stand or other raised structure.

Additionally, the movement of the handle 202 may permit the handle 202 to be moved into a position such that the handle 202 aligns with the hanger arm 210, as shown if FIG. 6B, and is therefore less likely to be bumped or inconveniently placed in a tight space, e.g., for hunting. In this handle-aligned position, i.e., the handle 202 is parallel with the hanger arm 210, according to some example embodiments, the trigger 230 may be safety deactivated to avoid accidental bumping to cause rotation of the penetrating member 208. Additionally, according to some example embodiments, the handle 202, in this position, may operate as a secondary hanger arm to hold various items. In this regard, the base of the handle may include an insertion point 207 to receive other element ends, such as the hook 205 shown in FIG. 6B.

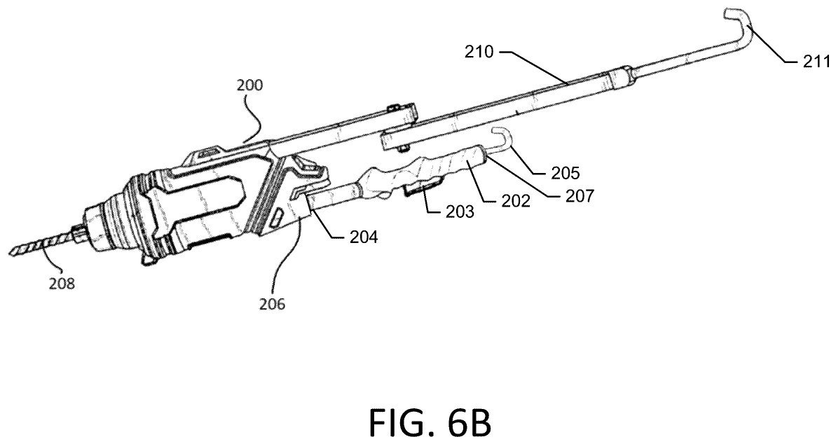

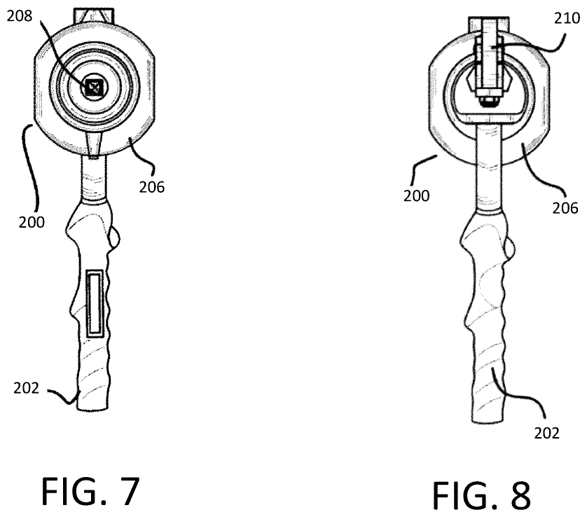

FIG. 7 shows a front view of the self-inserting tree hanger of FIG. 6A. FIG. 8 shows a rear view of the self-inserting tree hanger of FIG. 6A.

While the devices herein has been described in use with trees, the current disclosure is not so limited and the devices may be used with any surface, member, etc., into which the penetrating member 104 or alternate penetrating member 208 may penetrate. Indeed, the variable positions provided by the current disclosure devices allow for overhead, down, sideways, angled, etc., deployments of the hangers with minimal effort while the user remains in a fixed, stable position without having to twist or otherwise reposition themselves to gain purchase with the tree hanger devices.

Any of the tree hanging devices described herein can be presented as a combination kit. As used herein, the terms “combination kit” or “kit of parts” refers to the devices, apparatus, and any additional components that are used to package, sell, market, deliver, and/or provide the combination of parts/elements or a single element, such as a complete insertable tree hanging device, contained therein. Such additional components include, but are not limited to, packaging, blister packages, assembly tools, and the like. When one or more of the devices, apparatus, and any additional components described herein or a combination thereof (e.g., parts provided for customizing one insertable tree hanger into a distinct configuration different from the original configuration in the kit are provided simultaneously, the combination kit can contain the insertable tree hanger in a single embodiment, such as a pre-assembled hanger ready to function or in separate embodiments. When the devices, apparatus, and any additional components described herein or a combination thereof and/or kit components are not provided simultaneously, the combination kit can contain each component in separate embodiments. The separate kit components can be contained in a single package or in separate packages within the kit.

In some embodiments, the combination kit also includes instructions printed on or otherwise contained in a tangible medium of expression. The instructions can provide information regarding the devices, apparatus, and any additional components, safety information regarding the content of the devices, apparatus, and any additional components, instructions for use, and/or recommended/prohibited uses for the hanger contained therein. In some embodiments, the instructions can provide directions and protocols for assembling the hanger, using the hanger, maintaining the hanger, etc. In some embodiments, the instructions can provide one or more embodiments of the methods for forming a hanger such as any of the methods described in greater detail elsewhere herein.

Further embodiments are illustrated in the following examples which are given for illustrative purposes only and are not intended to limit the scope of the disclosure.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A tree hanger comprising:
a controllable motor disposed within a body of the tree hanger;
a penetrating member operably coupled to the controllable motor and extending from a first end of the body, the penetrating member being configured to rotate and penetrate into a supporting surface to support the tree hanger;
a hanger arm extending from the body at a second end of the body that is opposite the first end, the hanger arm being configured to support an item on a utility end of the hanger arm via a hanging member;
wherein the hangar arm comprises a pivoting element configured to change an angle of extension of the hanger arm from the body.

2. The tree hanger of claim 1, wherein a length of the hanger arm is greater than a length of the body of the tree hanger.

3. The tree hanger of claim 1, wherein the hanging member comprises a hook.

4. The tree hanger of claim 1, wherein the hanging member comprises a hoop net.

5. The tree hanger of claim 1 further comprising a plurality of pivoting elements including the pivoting element to change a direction of extension of the hanger arm from the body.

6. The tree hanger of claim 1, wherein the hanging member is removable and replaceable.

7. The tree hanger of claim 1, further comprising a handle that extends from the body in a non-parallel direction from an axis of rotation of the penetrating member.

8. The tree hanger of claim 7, wherein the handle is pivotable.

9. The tree hanger of claim 8, wherein the handle is pivotable into a stowed position such that the handle is configured to operate as a second hanger arm.

10. The tree hanger of claim 9, wherein the handle comprises a second hanging member.

11. The tree hanger of claim 10, wherein the second hanging member is a hook.

12. The tree hanger of claim 11, wherein the second hanging member is removable and replaceable.
